(19) United States
(12) Patent Application Publication
(10) Pub. No.: US 2026/0061856 A1
(43) Pub. Date: Mar. 5, 2026

(54) METHOD AND APPARATUS FOR PROTECTING BATTERY PERFORMANCE

(71) Applicants: HYUNDAI MOTOR COMPANY, Seoul (KR); KIA CORPORATION, Seoul (KR)

(72) Inventors: Mun Soon Kwon, Hwaseong-si (KR); Jae Woong Kim, Hwaseong-si (KR); Eung Chang Kim, Hwaseong-si (KR); Jae Kwon Lee, Hwaseong-si (KR); Yong Jae Kim, Hwaseong-si (KR); Sung Tae Kim, Hwaseong-si (KR); Myoung Soo Park, Hwaseong-si (KR)

(73) Assignees: HYUNDAI MOTOR COMPANY, Seoul (KR); KIA CORPORATION, Seoul (KR)

(21) Appl. No.: 19/082,863

(22) Filed: Mar. 18, 2025

(30) Foreign Application Priority Data
Sep. 2, 2024 (KR) 10-2024-0118263

(51) Int. Cl. B60L 15/20; B60L 3/12; B60L 7/18; B60L 58/12; B60L 58/16

(52) U.S. Cl. CPC B60L 15/2045; B60L 3/12; B60L 7/18; B60L 58/12; B60L 58/16; B60L 2240/545; B60L 2240/662; B60L 2250/26

(57) ABSTRACT

A method and apparatus protect battery performance. The battery protection method includes monitoring a state of a vehicle; determining, using a result of monitoring the state of the vehicle, that a high power peak has occurred in response to power of a battery being equal to or greater than a first threshold value; controlling power consumption of a load so that the high power peak is distributed; and compensating for the power consumption of the load.

### CROSS-REFERENCE TO RELATED APPLICATION

This application claims priority from Korean Patent Application No. 10-2024-0118263, filed on Sep. 2, 2024, the entire contents of which are hereby incorporated by reference for all purposes.

### TECHNICAL FIELD

The present disclosure relates to a method and apparatus for protecting battery performance and, more particularly, to a method and apparatus for protecting battery performance to delay the decrease of a state of charge (SoC) of a battery and enhance a state of health (SoH) of the battery.

### BACKGROUND

The content described below merely provides background information related to the present disclosure and does not constitute related art.

Electric vehicles are equipped with a high-voltage battery (hereinafter, referred to as a “battery”) storing energy to be provided to a motor and generates driving power by consuming the stored energy. Therefore, battery performance is an important factor in the design of electric vehicles.

A peak power of a battery may occur while a vehicle is driving. For example, when a vehicle accelerates, the torque of a motor rapidly increases due to the operation of an accelerator pedal, causing a drop in a battery voltage and an increase in the fluctuation of a ripple current of the battery, which results in a peak of battery power. As another example, when a vehicle using a regenerative braking mode decelerates, the ripple current fluctuation of the battery increases due to the operation of a brake pedal, resulting in a power peak of the battery. The power peak causes heat loss, thereby reducing battery performance.

If a regenerative braking amount increases, a temperature rise of the battery is delayed. The delay in temperature rise of the battery improves a SoH of the battery. In addition, when the battery is equal to or higher than a certain temperature in an electric vehicle, the output of the battery is controlled to limit performance thereof, and thus, if the temperature rise of the battery is controlled to be delayed, a timing of limiting the performance of the battery may be postponed.

### SUMMARY

In view of the above, the present disclosure is to protect battery performance by delaying a decrease in a state of charge (SoC) of a battery and improving a state of health (SoH) of the battery by controlling a power peak of the battery to be distributed or a regenerative braking amount to be increased.

The problems to be solved by the present disclosure are not limited to the problems mentioned above, and other problems not mentioned may be clearly understood by those having ordinary skill in the art from the description below.

According to an embodiment, a battery protection method includes: monitoring a state of a vehicle; determining, using a result of monitoring the state of the vehicle, that a high power peak has occurred in response to power of a battery being equal to or greater than a first threshold value; controlling power consumption of a load so that the high power peak is distributed; and compensating for the power consumption of the load.

According to another embodiment, a battery protection method includes: monitoring a state of a vehicle; determining, using a result of monitoring the state of the vehicle, whether to control a regenerative braking amount; and controlling the regenerative braking amount to increase.

According to another embodiment, an apparatus includes: at least one memory storing instructions; and at least one processor. The at least one processor, by executing the instructions, is configured to monitor a state of a vehicle, determine, using a result of monitoring the state of the vehicle, that a high power peak has occurred when power of a battery is equal to or greater than a first threshold value, control power consumption of a load so that the high power peak is distributed, and compensate for power consumption of the load. The state of the vehicle includes at least one of power of the battery, voltage of the battery, current of the battery, rated voltage of the battery, state of charge (SoC) of the battery, state of health (SoH) of the battery, power consumption of the load, output of the load, voltage of the load, current of the load, rated voltage of the load, speed of the vehicle, acceleration of the vehicle, deceleration of the vehicle, a degree of depression of an accelerator pedal, a degree of depression of a brake pedal, fluctuation of a ripple current of the battery, outside temperature, a difference between battery temperature and an outside temperature, a regenerative braking amount, or a performance limit point of the battery.

According to another embodiment, an apparatus includes: at least one memory storing instructions; and at least one processor. The at least one processor, by executing the instructions, is configured to monitor a state of a vehicle, determines, using a result of monitoring the state of the vehicle, whether to control a regenerative braking amount, and control the regenerative braking amount to increase. The state of the vehicle includes at least one of power of a battery, voltage of the battery, current of the battery, rated voltage of the battery, state of charge (SoC) of the battery, state of health (SoH) of the battery, power consumption of a load, output of the load, voltage of the load, current of the load, rated voltage of the load, speed of the vehicle, acceleration of the vehicle, deceleration of the vehicle, a degree of depression of an accelerator pedal, a degree of depression of a brake pedal, fluctuation of a ripple current of the battery, outside temperature, a difference between battery temperature and an outside temperature, a regenerative braking amount, or a performance limit point of the battery.

The present disclosure may protect battery performance by controlling the power peak of a battery to be distributed or a regenerative braking amount to be increased, thereby delaying a decrease in battery SoC and improving battery SoH.

The effects of the present disclosure are not limited to the effects mentioned above, and other effects not mentioned herein should be more clearly understood by those having ordinary skill in the art from the description below.

### BRIEF DESCRIPTION OF THE DRAWINGS

FIG. 1 is a block diagram schematically illustrating a battery protection system according to an embodiment of the present disclosure.

FIG. 2 is a block diagram schematically illustrating a battery protection device according to an embodiment of the present disclosure.

FIG. 3 is a diagram illustrating the relationship between depression of an accelerator pedal, a vehicle speed, and a battery voltage.

FIG. 4 is a flowchart illustrating an operation of controlling power consumption of a load by a battery protection device according to an embodiment of the present disclosure.

FIGS. 5A and 5B are diagrams illustrating a process in which a battery protection device controls power consumption of a load according to an embodiment of the present disclosure.

FIG. 6 is a diagram illustrating a method in which a battery protection device controls power consumption of a load by reflecting hysteresis according to an embodiment of the present disclosure.

FIG. 7 is a flowchart illustrating a process in which a battery protection device controls a regenerative braking amount according to an embodiment of the present disclosure.

FIG. 8 is a diagram illustrating a relationship between power consumption compensation of a load and battery heat loss.

FIG. 9 is a flowchart illustrating a process of controlling power consumption of a load by a battery protection method according to an embodiment of the present disclosure.

FIG. 10 is a flowchart illustrating a process of controlling a regenerative braking amount by a battery protection method according to an embodiment of the present disclosure.

FIG. 11 is a block diagram schematically illustrating a computing device that may be used to implement a method according to an embodiment of the present disclosure.

The drawings described herein are for illustration purposes only and are not intended to limit the scope of the present disclosure in any way.

### DETAILED DESCRIPTION

Hereinafter, embodiments of the present disclosure are described in detail with reference to the accompanying drawings. In the following description, like reference numerals designate like elements, although the elements are shown in different drawings. Further, in the following description of some embodiments, a detailed description of known functions and configurations incorporated therein has been omitted for the purpose of clarity and for brevity.

Additionally, various terms such as first, second, A, B, (a), (b), and the like, are used solely to differentiate one component from the other but not to imply or suggest the substances, order, or sequence of the components. Throughout the present disclosure, when a part ‘includes’or ‘comprises’a component, the part is intended to further include other components and not intended to exclude other components unless specifically stated to the contrary. The terms such as ‘unit’, ‘module’, and the like refer to one or more units for processing at least one function or operation, which may be implemented by hardware, software, or a combination thereof. When a processor, controller, module, component, device, element, or the like of the present disclosure is described as having a purpose or performing an operation, function, or the like, the processor, controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

The following detailed description, together with the accompanying drawings, is intended to illustrate embodiments of the present disclosure and is not intended to represent the only embodiments in which the disclosure may be practiced.

Hereinafter, a vehicle may be an electric vehicle (EV). The EV vehicle includes a battery electric vehicle (BEV), a fuel cell electric vehicle (FCEV), and a plug-in hybrid electric vehicle (PHEV).

Hereinafter, the term peak power refers to a battery power that is equal to or greater than a first threshold value or that is equal to or less than a second threshold value. The first threshold value is a value for determining a high power peak, and the second threshold value is a value for determining a low power peak. The first threshold value and the second threshold value may be set by a user or may be automatically set by an electronic controller (ECU) provided in a vehicle.

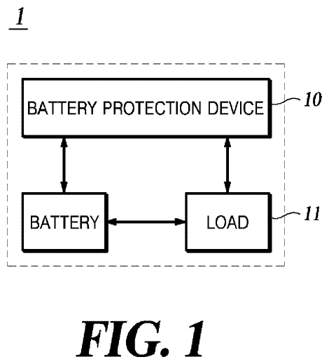

FIG. 1 is a block diagram schematically illustrating a battery protection system according to an embodiment of the present disclosure.

A battery protection system 1 may be implemented by being executed by one or more physical computing devices including a battery protection device 10. The battery protection device 10 performs an operation to protect the performance of the battery by distributing a peak of battery power or increasing a regenerative braking amount. The battery protection device 10 may protect the performance of the battery and improve the energy efficiency of the battery by delaying a decrease of a state of charge (SoC) of the battery or improving a state of health (SoH) of the battery.

A load 11 is a device controlled to increase or decrease power consumption by the battery protection device 10 in order to distribute a power peak of the battery, and includes an air-conditioning heater, an electric compressor, and an inverter.

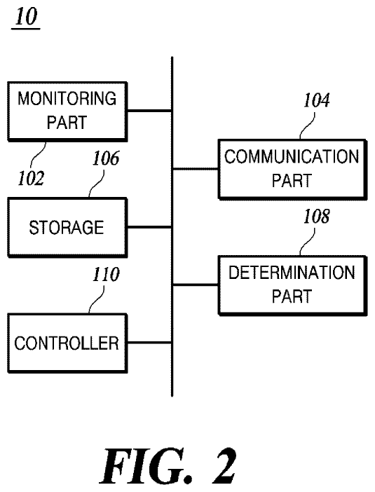

FIG. 2 is a block diagram schematically illustrating a battery protection device according to an embodiment of the present disclosure.

The battery protection device 10 may include all or some of a monitoring part 102, a communication part 104, a storage 106, a determination part 108, and a controller 110. Not all blocks illustrated in FIG. 2 are essential components, and some blocks included in the battery protection device 10 in other embodiments may be added, changed, or deleted. The components illustrated in FIG. 2 represent functionally distinct elements, and at least one of the components may be implemented to be integrated with one another in an actual physical environment.

The monitoring part 102 monitors a vehicle state. The vehicle state includes a battery power, a battery voltage, a battery current, a battery rated voltage, a battery SoC, a battery SoH, load power consumption, a load output, a load voltage, a load current, a load rated voltage, a motor power, a motor voltage, a motor current, motor current consumption, a motor rated voltage, a vehicle power, a vehicle voltage, a vehicle current, a vehicle speed, acceleration of the vehicle, deceleration of the vehicle, a degree of depression of an accelerator pedal, a degree of depression of a brake pedal, ripple current fluctuation (i.e., fluctuation of a ripple current of the battery), outside temperature, a difference between the battery temperature and outside temperature, regenerative braking amount, and battery performance limit point. The monitoring part 102 may be implemented using, for example, a battery management system (BMS).

The communication part 104 may perform wired or wireless communication with other components of the battery protection device 10, a vehicle internal device (not shown), or a communication network (not shown). The communication part 104 may include a communication module that supports at least one of various wired and wireless communication methods. For example, the communication module may be implemented in the form of a chipset. The wireless communication supported by the communication part 104 may be wireless local area network (WLAN), wireless broadband (Wibro), world interoperability for microwave access (Wimax), high speed downlink packet access (HSDPA), global system for mobile communications (GSM), code division multiple access (CDMA), wideband CDMA (WCDMA), long term evolution (LTE), and the like. The wired communication supported by the communication part 104 may be a universal serial bus (USB) or high definition multimedia interface (HDMI), and the like.

The storage 106 may store a program for the operation of the battery protection device 10 and may temporarily store data used in the operation process of the battery protection device 10. For example, information on the state of the vehicle, such as the power, voltage, current of the battery, and power consumption of the load, may be stored for the operation of the battery protection device 10.

The determination part 108 determines whether a power peak occurs using a result monitored by the monitoring part 102. The determination part 108 determines that a high power peak occurs when the battery power is equal to or greater than a first threshold value. The determination part 108 determines that a low power peak occurs when the battery power is equal to or less than a second threshold value. For example, if the first threshold value for determining whether a high power peak occurs is set to 40 kW, the determination part 108 determines that a high power peak occurs in a section in which the battery power is equal to or greater than 40 kW. If the second threshold value for determining whether a low power peak occurs is set to −17 kW, the determination part 108 determines that a low power peak occurs in a section in which the battery power is equal to or less than −17 kW.

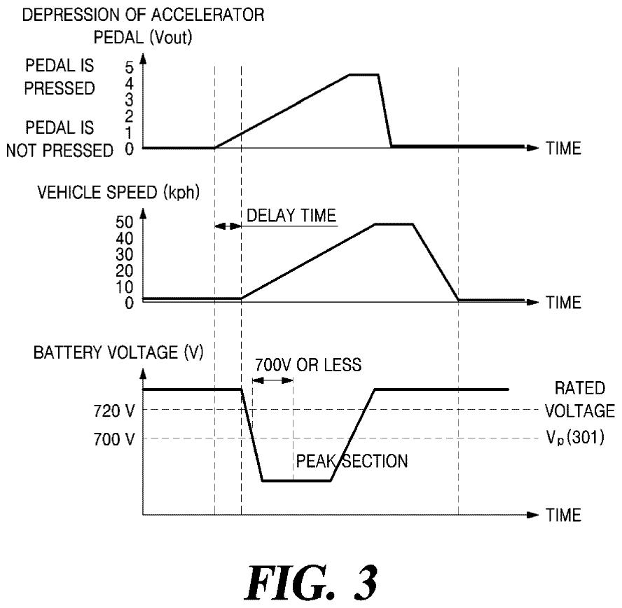

FIG. 3 is a diagram illustrating a relationship between depression of an accelerator pedal, a vehicle speed, and a battery voltage.

The determination part 108 may also determine whether a power peak occurs using the accelerator pedal. Depending on the degree of depression of the accelerator pedal of the vehicle, a delay time occurs in a change in power consumption of the load. Depending on the degree of depression of the accelerator pedal of the vehicle, a delay time occurs in a change in the speed of the vehicle and current consumption of the motor. The speed of the vehicle changes due to a change in current consumption of the motor. Therefore, the vehicle speed and the magnitude of current consumption of the motor change in proportion to the degree of depression of the accelerator pedal. Therefore, the determination part 108 may determine whether a power peak occurs using the accelerator pedal even if a change in the current of the battery is not detected. For example, it may be determined that a low power peak occurs in a section in which the voltage of the battery is lower by comparing the voltage of the battery with a voltage Vp 301 at which the power peak occurs.

The determination part 108 may also determine whether a power peak occurs using a voltage drop of the load. The determination part 108 may also determine whether a power peak occurs using a change in the current flowing through the load.

The determination part 108 may determine whether battery protection is necessary using the result monitored by the monitoring part 102. If it is determined that the SoC decrease of the battery needs to be delayed or the SoH of the battery needs to be improved, the determination part 108 determines that the battery needs to be protected. If battery protection is necessary, the determination part 108 determines that the regenerative braking amount needs to be controlled. For example, if the speed of the vehicle is maintained within a preset range for a preset time, the determination part 108 determines that battery protection is necessary and therefore the regenerative braking amount needs to be controlled. Alternatively, in a sudden braking section, the determination part 108 determines that battery protection is necessary and therefore the regenerative braking amount needs to be controlled. The determination part 108 may determine the sudden braking section based on a degree of depression of a brake pedal. Alternatively, if the outside temperature is higher than a preset temperature compared to the battery temperature (e.g., if the outside temperature is equal to or higher than the battery temperature by an amount equal to or greater than a preset value), the determination part 108 determines that battery protection is necessary and therefore the regenerative braking amount needs to be controlled. The preset range, preset time, and preset temperature may be set by the user or automatically set by the electronic control unit (ECU) provided in the vehicle.

The controller 110 controls power consumption of the load using the determination result of the determination part 108. For example, when a high power peak occurs, the controller 110 controls power consumption of the load to decrease in order to distribute the high power peak. The controller 110 may also compensate for the power consumption of the load by controlling the power consumption of the load to increase by the amount controlled to decrease. As another example, when a low power peak occurs, the controller 110 controls the power consumption of the load to increase in order to distribute the low power peak. The controller 110 may also compensate for the power consumption of the load by controlling the power consumption of the load to decrease by the amount controlled to increase.

The controller 110 may also control the power consumption of the load by determining a power saving mode stage of the load. The controller 110 may control the load by determining the power saving mode stage as an ultra power saving mode. The ultra power saving mode is a control method of maximizing a power saving effect within a range that does not affect the driving of the vehicle. The controller 110 may also determine the power saving mode stage to maintain an optimal vehicle condition. The optimal vehicle condition includes a state in which the energy efficiency of the vehicle is maximized or a state in which heat loss of the battery is minimized. The controller 110 may determine the power saving mode stage of the load so that the vehicle may maintain an optimal condition when a power peak occurs by considering the speed of the vehicle and the power consumption of the load.

The controller 110 controls the regenerative braking amount using the determination result of the determination part 108. The controller 110 may control the regenerative braking amount to increase by increasing regenerative braking force. The controller 110 may maintain the required braking force constantly by decreasing hydraulic braking force and increasing regenerative braking force. The required braking force is braking force required to stop the vehicle.

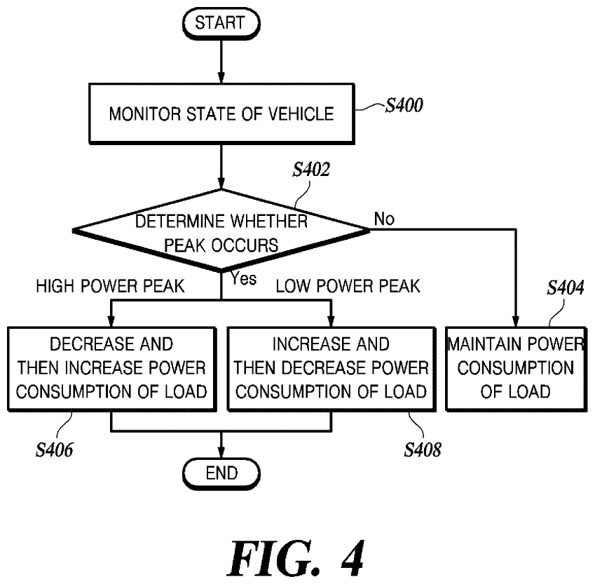

FIG. 4 is a flowchart illustrating an operation of the battery protection device to control power consumption of a load according to an embodiment of the present disclosure.

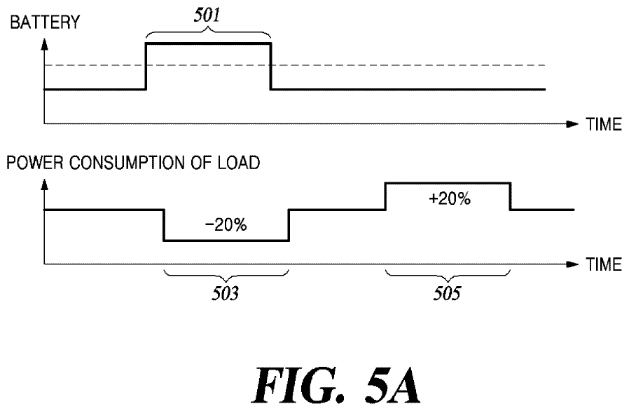

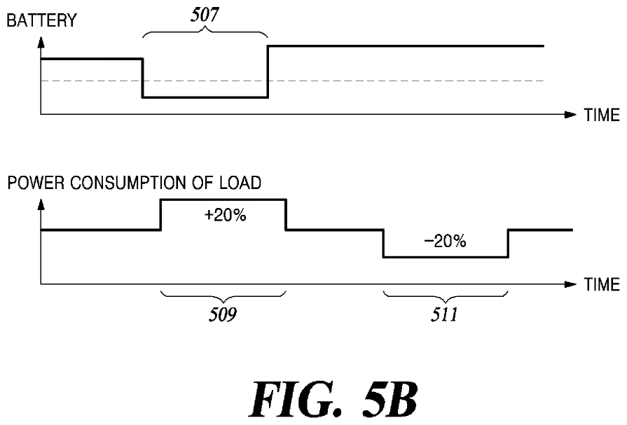

FIGS. 5A and 5B are diagrams illustrating a process of the battery protection device to control power consumption of a load according to an embodiment of the present disclosure.

The battery protection device 10 monitors the state of the vehicle (an operation S400). The state of the vehicle includes battery power, battery voltage, battery current, battery rated voltage, battery SoC, battery SoH, load power consumption, load output, load voltage, load current, load rated voltage, motor power, motor voltage, motor current, motor current consumption, motor rated voltage, vehicle power, vehicle voltage, vehicle current, vehicle speed, acceleration of the vehicle, deceleration of the vehicle, a degree of depression of an accelerator pedal, a degree of depression of a brake pedal, ripple current fluctuation, outside temperature, a difference between battery temperature and outside temperature, regenerative braking amount, and battery performance limit point.

The battery protection device 10 determines whether a battery power peak occurs using a result of monitoring the state of the vehicle (an operation S402). The battery protection device 10 determines that a high power peak 501 has occurred when the battery power is equal to or greater than the first threshold value. The battery protection device 10 determines that a low power peak 507 has occurred when the battery power is less than or equal to the second threshold value. The battery protection device 10 may determine whether a battery power peak has occurred using the accelerator pedal. The battery protection device 10 may determine whether a battery power peak has occurred using the accelerator pedal even if a change in consumption current of the battery is not detected. The battery protection device 10 may determine whether a power peak has occurred by comparing the battery voltage with the voltage at which a power peak has occurred. The battery protection device 10 may determine whether a power peak has occurred using a voltage drop of the load. The battery protection device 10 may determine whether a power peak has occurred using a change in current flowing through the load.

If it is determined that a power peak has not occurred, the battery protection device 10 monitors the state of the vehicle and controls the power consumption of the load to be maintained (an operation S404).

If it is determined that a high power peak has occurred, the battery protection device 10 controls power consumption of the load to decrease in order to distribute the high power peak (an operation S406, 503). The battery protection device 10 controls the power consumption of the load to increase by the amount controlled to decrease in order to returns it to the original state. In order to compensate for the power consumption of the load, the battery protection device 10 controls the power consumption of the load to increase by the amount controlled to decrease (the operation S406, 505).

If it is determined that a low power peak has occurred, the battery protection device 10 controls the power consumption of the load to increase in order to distribute the low power peak (an operation S408, 509). The battery protection device 10 controls the power consumption of the load to decrease by the amount controlled to increase in order to return it to the original state. In order to compensate for the power consumption of the load, the battery protection device 10 controls the power consumption of the load to decrease by the amount controlled to increase (the operation S408, 511).

The battery protection device 10 may control the power consumption of the load by determining a power saving mode stage of the load. The battery protection device 10 may also control the load by determining the power saving mode stage as an ultra power saving mode. The ultra power saving mode is a control method of maximizing a power saving effect within a range that does not affect the driving of the vehicle.

The battery protection device 10 controls the power consumption of the load, thereby reducing heat loss of the battery due to a power peak and reducing the battery consumption. The battery protection device 10 delays the decrease in the SoC of the battery and improves the SoH of the battery, thereby protecting the battery and increasing a driving range and energy efficiency of the vehicle.

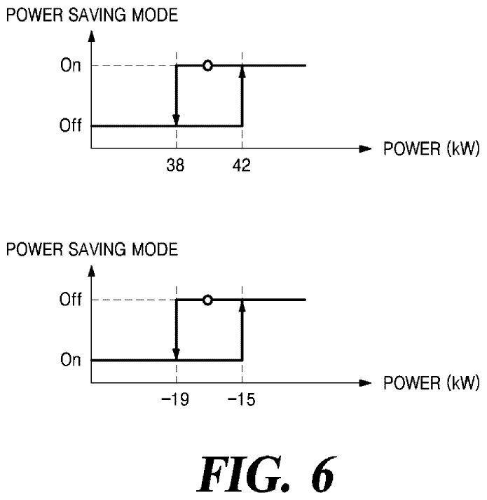

FIG. 6 is a drawing illustrating a method in which a battery protection device controls power consumption of a load by reflecting hysteresis according to an embodiment of the present disclosure.

The battery protection device 10 may control the power consumption of the load by determining the power saving mode state by reflecting a hysteresis effect of the battery power within a setting value range. Therefore, the stability of the battery may be improved by allowing the battery power to change smoothly and maintain a constant state. The battery protection device 10 may also increase a battery usage time and energy efficiency. The preset value may be set by the user or automatically set by the ECU provided in the vehicle. Referring to FIG. 6, the power saving mode of the load is controlled by reflecting the hysteresis in the range of ±2 kW of the power peak, and in a situation in which it is determined that a high power peak has occurred, if the battery power is 38 kW or 42 kW, the power saving mode state of the load is controlled to be changed. In a situation in which it is determined that a low power peak has occurred, if the battery power is −19 kW or −15 kW, the power saving mode state of the load is controlled to be changed.

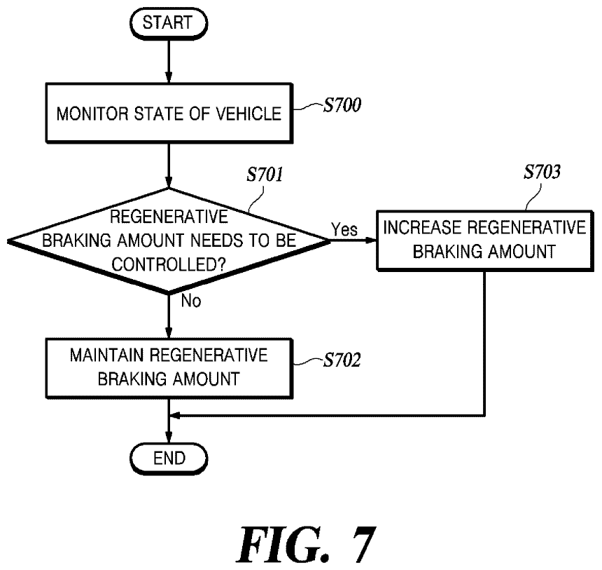

FIG. 7 is a drawing illustrating a process in which a battery protection device controls a regenerative braking amount according to an embodiment of the present disclosure.

The battery protection device 10 monitors the state of the vehicle (an operation S700). The vehicle state includes battery power, battery voltage, battery current, battery rated voltage, battery SoC, battery SoH, load power consumption, load output, load voltage, load current, load rated voltage, motor power, motor voltage, motor current, motor current consumption, motor rated voltage, vehicle power, vehicle voltage, vehicle current, vehicle speed, acceleration of the vehicle, deceleration of the vehicle, a degree of depression of an accelerator pedal, a degree of depression of a brake pedal, ripple current fluctuation, outside temperature, a difference between battery temperature and outside temperature, a regenerative braking amount, and a battery performance limit point.

The battery protection device 10 determines whether to control the regenerative braking amount using the monitoring result (an operation S701). If it is determined that the battery needs to be protected, the battery protection device 10 determines that the regenerative braking amount needs to be controlled. If it is determined that the SoC decrease of the battery needs to be delayed or the SoH of the battery needs to be improved, the battery protection device 10 determines that the battery needs to be protected. The battery protection device 10 determines that the battery needs to be protected when the vehicle speed is maintained within a preset range for a preset time. The battery protection device 10 determines that the battery needs to be protected in a sudden braking section. The battery protection device 10 determines that the battery needs to be protected when the outside temperature is higher than a preset temperature compared to the battery temperature (e.g., when the outside temperature is equal to or higher than the battery temperature by an amount equal to or greater than a preset value).

The battery protection device 10 maintains the regenerative braking amount if it is not determined that the regenerative braking amount needs to be controlled (an operation S702).

If it is determined that the regenerative braking amount needs to be controlled, the battery protection device 10 controls the regenerative braking amount to increase (an operation S703). If it is determined that the battery needs to be protected, the battery protection device 10 controls the regenerative braking amount to increase. The battery protection device 10 may increase the regenerative braking amount by increasing the regenerative braking force. The battery protection device 10 may maintain the required braking force constantly by reducing the hydraulic braking force and increasing the regenerative braking force. For example, if the speed of the vehicle is maintained within a preset range for a preset time, the battery protection device 10 determines that the battery needs to be protected and controls the regenerative braking amount to increase. Alternatively, in the case of sudden braking, the battery protection device 10 determines that the battery needs to be protected and controls the regenerative braking amount to increase. The battery protection device 10 may determine whether sudden braking is performed based on the degree of depression of the brake pedal. Or, if the outside temperature is higher than the preset temperature compared to the battery temperature (e.g., if t he outside temperature is equal to or higher than the battery temperature by an amount equal to or greater than a preset value), the battery protection device 10 determines that the battery needs to be protected and controls the regenerative braking amount to increase.

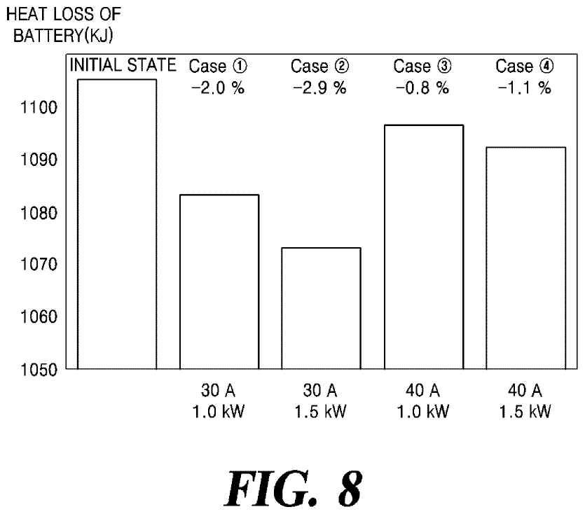

FIG. 8 is a diagram illustrating a relationship between power consumption compensation of a load and battery heat loss.

When the battery current is 30 A or higher, it is determined that a high power peak has occurred and the battery protection device controls power consumption of the load to decrease by 1.0 kW and then controls power consumption of the load to increase by 1.0 kW, and thus, the battery heat loss decreases by 2% (Case \textcircled{1}).

When the battery current is 30 A or higher, it is determined that a high power peak has occurred wand the battery protection device controls power consumption of the load to decrease by 1.5 kW and then controls power consumption of the load to increase by 1.5 kW, and thus, the battery heat loss decreases by 2.9% (Case \textcircled{2}).

When the battery current is 40 A or higher, it is determined that a high power peak has occurred and the battery protection device controls power consumption of the load to decrease by 1.0 kW and then controls power consumption of the load to increase by 1.0 kW, and thus, the battery heat loss decreases by 0.8% (Case \textcircled{3}).

When the battery current is 40 A or higher, it is determined that a high power peak has occurred and the battery protection device controls power consumption of the load to decrease by 1.5 kW and then controls power consumption of the load to increase by 1.5 kW, and thus, the battery heat loss decreases by 1.1% Case \textcircled{4}.

Therefore, as the threshold value for determining that a power peak has occurred decreases and as the power consumption compensation of the load increases, the battery heat loss decreases.

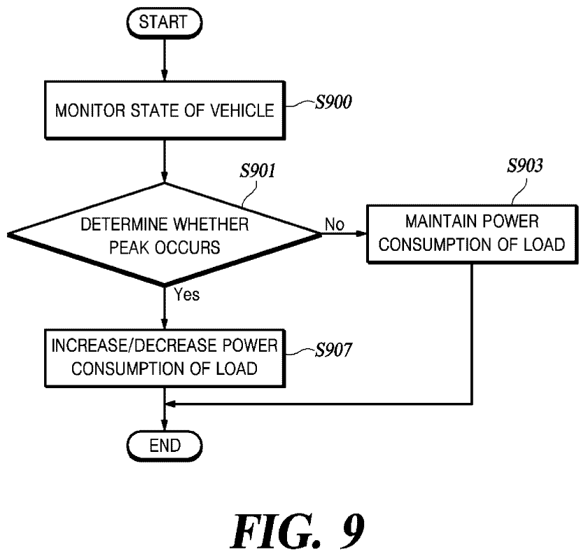

FIG. 9 is a flowchart illustrating a process of controlling power consumption of a load by a battery protection method according to an embodiment of the present disclosure. The method illustrated in FIG. 9 may be implemented by being executed by the battery protection system 1. The following description is given in terms of the operation performed by the battery protection system 1.

The battery protection system 1 monitors the state of the vehicle (an operation S900). The state of the vehicle includes battery power, battery voltage, battery current, battery rated voltage, battery SoC, battery SoH, load power consumption, load output, load voltage, load current, load rated voltage, motor power, motor voltage, motor current, motor current consumption, motor rated voltage, vehicle power, vehicle voltage, vehicle current, vehicle speed, acceleration of the vehicle, deceleration of the vehicle, a degree of depression of an acceleration pedal, a degree of depression of a brake pedal, ripple current fluctuation, an outside temperature, a difference between battery temperature and outside temperature, a regenerative braking amount, and a battery performance limit point.

The battery protection system 1 determines whether a battery power peak occurs using a monitoring result (an operation S901). The battery protection system 1 determines that a high power peak 401 has occurred when the battery power is equal to or greater than the first threshold value. The battery protection device 10 determines that a low power peak has occurred when the battery power is equal to or lower than the second threshold value. The battery protection system 1 may also determine whether a battery power peak has occurred using the accelerator pedal. The battery protection system 1 may determine whether a battery power peak has occurred using the accelerator pedal even if a change in consumption current of the battery is not detected. The battery protection system 1 may also determine whether a power peak has occurred by comparing the battery voltage with the voltage at which a power peak has occurred. The battery protection system 1 may also determine whether a power peak has occurred using a voltage drop of the load. The battery protection system 1 may also determine whether a power peak has occurred using a change in current flowing through the load.

If it is determined that a power peak has not occurred, the battery protection system 1 monitors the state of the vehicle and controls the power consumption of the load to be maintained (an operation S903).

If it is determined that a high power peak has occurred, the battery protection system 1 controls the power consumption of the load to be reduced in order to distribute the high power peak (an operation S907). The battery protection system 1 controls the power consumption of the load to increase by the amount controlled to decrease to returns it to the original state. The battery protection system 1 controls the power consumption of the load to increase by the amount controlled to decrease to compensate for the power consumption of the load.

If it is determined that a low power peak has occurred, the battery protection system 1 controls the power consumption of the load to increase in order to distribute the low power peak (the operation S907). If it is determined that a low power peak has occurred, the battery protection system 1 controls the load power consumption to increase. The battery protection system 1 controls the power consumption of the load to decrease by the amount controlled to increase to return it to the original state. The battery protection system 1 controls the power consumption of the load to decrease by the amount controlled to increase to compensate for the power consumption of the load.

The battery protection system 1 may also control the power consumption of the load by determining the load power saving mode stage. The battery protection system 1 may also control the load by determining the load power saving mode stage as an ultra power saving mode. The ultra power saving mode is a control method of maximizing a power saving effect within a range that does not affect the driving of the vehicle.

The battery protection system 1 controls the power consumption of the load, thereby reducing heat loss of the battery due to the power peak and reducing the battery consumption. The battery protection system 1 delays the decrease in the SoC of the battery and improves the SoH of the battery, thereby protecting the performance of the battery and increasing the driving range and energy efficiency of the vehicle.

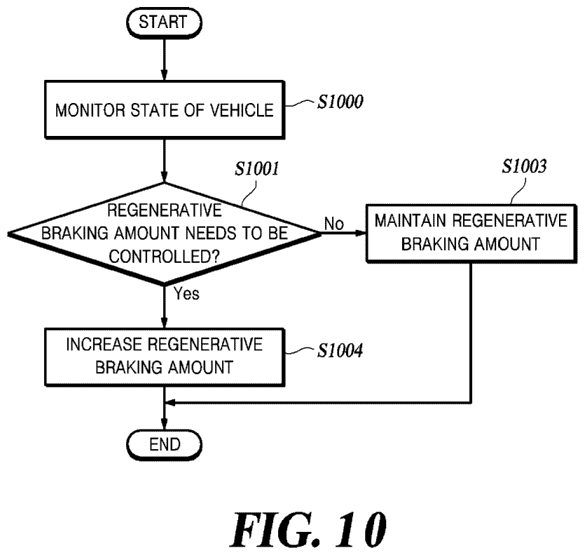

FIG. 10 is a flowchart illustrating a process of controlling a regenerative braking amount by a battery protection method according to an embodiment of the present disclosure. The method illustrated in FIG. 10 may be implemented by being executed by the battery protection system 1. The following description is given in terms of the operation performed by the battery protection system 1.

The battery protection system 1 monitors the state of the vehicle (an operation S1000). The state of the vehicle includes battery power, battery voltage, battery current, battery rated voltage, battery SoC, battery SoH, load power consumption, load output, load voltage, load current, load rated voltage, motor power, motor voltage, motor current, motor current consumption, motor rated voltage, vehicle power, vehicle voltage, vehicle current, vehicle speed, acceleration of the vehicle, deceleration of the vehicle, a degree of depression of the accelerator pedal, a degree of depression of the brake pedal, ripple current fluctuation, outside temperature, a difference between battery temperature and outside temperature, a regenerative braking amount, and a battery performance limit point.

The battery protection system 1 determines whether a regenerative braking amount needs to be controlled using a monitoring result (an operation S1001). If it is determined that the battery needs to be protected, the battery protection system 1 determines that the regenerative braking amount needs to be controlled. If it is determined that the SoC decrease of the battery needs to be delayed or the SoH of the battery needs to be improved, the battery protection system 1 determines that the battery needs to be protected. If the vehicle speed is maintained within a preset range for a preset time, the battery protection system 1 determines that the battery needs to be protected. The battery protection system 1 determines that the battery needs to be protected in A sudden braking section. If an outside temperature is equal to or higher than a preset temperature compared to the battery temperature (e.g., if the outside temperature is equal to or higher than the battery temperature by an amount equal to or greater than a preset value), the battery protection system 1 determines that the battery needs to be protected.

If it is determined that battery protection is not necessary, the battery protection system 1 maintains the regenerative braking amount (an operation S1003).

If battery protection is necessary, the battery protection system 1 controls the regenerative braking amount to increase (an operation S1004). The battery protection system 1 may increase the regenerative braking amount by increasing the regenerative braking force. The battery protection system 1 may maintain the required braking force constantly by reducing the hydraulic braking force and increasing the regenerative braking force. For example, when the speed of the vehicle is maintained within a preset range for a preset time, the battery protection system 1 determines that the battery needs to be protected and controls the regenerative braking amount to increase. Alternatively, in the case of sudden braking, the battery protection system 1 determines that the battery needs to be protected and controls the regenerative braking amount to increase. The battery protection system 1 may determine whether sudden braking occurs based on the degree of depression of the brake pedal. Or, when the outside temperature is equal to or higher than a preset temperature compared to the battery temperature (e.g., when the outside temperature is equal to or higher than the battery temperature by an amount equal to or greater than a preset value), the battery protection system 1 determines that the battery needs to be protected and controls the regenerative braking amount to increase.

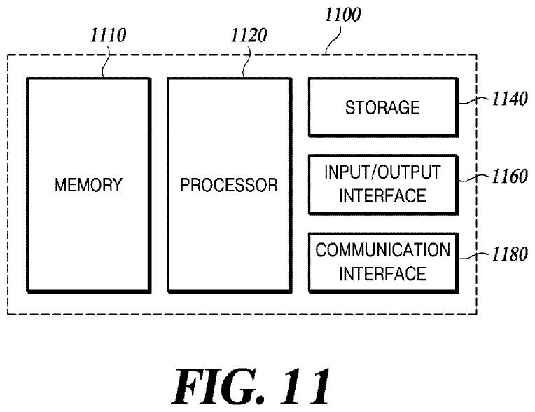

FIG. 11 is a block diagram schematically illustrating a computing device that may be used to implement a method according to an embodiment of the present disclosure.

A computing device 1100 may include some or all of a memory 1110, a processor 1120, a storage 1140, an input/output (I/O) interface 1160, and a communication interface 1180. The computing device 1100 may structurally and/or functionally include at least a part of the battery protection device 10. The computing device 1100 may be a stationary computing device, such as a desktop computer, a server, an artificial intelligence (AI) accelerator, and the like, as well as a portable computing device, such as a laptop computer, a smartphone, and the like.

The memory 1110 may store a program that causes the processor 1120 to perform a method or operation according to various embodiments of the present disclosure. For example, the program may include a plurality of instructions executable by the processor 1120, and the method illustrated in FIG. 7 may be performed by executing the plurality of instructions by the processor 1120.

The memory 1110 may be a single memory or a plurality of memories. In this case, information required to perform a method or operation according to various embodiments of the present disclosure may be stored in the single memory or divided and stored in the plurality of memories. When the memory 1110 is configured as a plurality of memories, the plurality of memories may be physically separated.

The memory 1110 may include at least one of volatile memory and nonvolatile memory. The volatile memory may include static random access memory (SRAM) or dynamic random access memory (DRAM, and the nonvolatile memory may include flash memory, and the like.

The processor 1120 may include at least one core capable of executing at least one instruction. The processor 1120 may execute instructions stored in the memory 1110. The processor 1120 may be a single processor or a plurality of processors.

The storage 1140 maintains stored data even when power supplied to the computing device 1100 is cut off. For example, the storage 1140 may include nonvolatile memory, and may include storage medium, such as magnetic tape, optical disk, or magnetic disk.

A program stored in the storage 1140 may be loaded into the memory 1110 before being executed by the processor 1120. The storage 1140 may store a file written in a programming language, and a program generated from the file by a compiler or the like may be loaded into the memory 1110. The storage 1140 may store data to be processed by the processor 1120 and/or data processed by the processor 1120.

The I/O interface 1160 may include an input device, such as a keyboard, a mouse, and the like, and an output device, such as a display device, a printer, and the like. The user may trigger the execution of a program by the processor 1120 and/or check a processing result of the processor 1120 through the I/O interface.

The communication interface 1180 may provide access to an external network. For example, the computing device 1100 may communicate with other devices through the communication interface 1180.

Each element of the apparatus or method in accordance with the present disclosure may be implemented in hardware, software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

A computer-readable storage medium includes any type of recording device on which data readable by a computer system can be stored. Such computer-readable storage media may include non-volatile or non-transitory media such as ready-only memory (ROM), compact disc-ROM (CD-ROM), magnetic tape, floppy disks, memory cards, hard disks, magneto-optical disks, storage devices, and the like. Additionally, it may also include transitory media such as data transmission mediums. Furthermore, computer-readable storage media may be distributed across network-connected computer systems, with code stored and executed in a distributed manner.

Although operations are illustrated in the flowcharts/timing charts in this specification as being sequentially performed, this is merely an exemple description of the technical idea of one embodiment of the present disclosure. In other words, those having ordinary skill in the art to which one embodiment of the present disclosure belongs may appreciate that various modifications and changes can be made without departing from essential features of an embodiment of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the claimed disclosure. Therefore, embodiments of the present disclosure have been described for the sake of brevity and clarity. The scope of the technical idea of the present disclosure is not limited by the illustrations. Accordingly, one of ordinary skill would understand that the scope of the claimed disclosure is not to be limited by the above explicitly described embodiments but by the claims and equivalents thereof.

What is claimed is:

1. A battery protection method comprising:
monitoring a state of a vehicle;
determining, using a result of monitoring the state of the vehicle, that a high power peak has occurred in response to power of a battery being equal to or greater than a first threshold value;
controlling power consumption of a load so that the high power peak is distributed; and
compensating for the power consumption of the load.

2. The battery protection method of claim 1, wherein the state of the vehicle includes at least one of power of the battery, voltage of the battery, current of the battery, rated voltage of the battery, state of charge (SoC) of the battery, state of health (SoH) of the battery, power consumption of the load, output of the load, voltage of the load, current of the load, rated voltage of the load, speed of the vehicle, acceleration of the vehicle, deceleration of the vehicle, a degree of depression of an accelerator pedal, a degree of depression of a brake pedal, fluctuation of a ripple current of the battery, outside temperature, a difference between battery temperature and an outside temperature, a regenerative braking amount, or a performance limit point of the battery.

3. The battery protection method of claim 2, wherein controlling the power consumption of the load comprises:
controlling the power consumption of the load to decrease.

4. The battery protection method of claim 3, wherein compensating for the power consumption of the load comprises:
controlling the power consumption of the load to increase.

5. The battery protection method of claim 4, wherein compensating for the power consumption of the load comprises:
controlling the power consumption of the load to increase by an amount of the power consumption of the load controlled to decrease to distribute the high power peak.

6. The battery protection method of claim 5, wherein controlling the power consumption of the load comprises:
controlling a power saving mode of the load by reflecting a hysteresis effect of the power of the battery within a preset value range.

7. A battery protection method comprising:
monitoring a state of a vehicle;
determining, using a result of monitoring the state of the vehicle, whether to control a regenerative braking amount; and
controlling the regenerative braking amount to increase.

8. The battery protection method of claim 7, wherein the state of the vehicle includes at least one of power of a battery, voltage of the battery, current of the battery, rated voltage of the battery, state of charge (SoC) of the battery, state of health (SoH) of the battery, power consumption of a load, output of the load, voltage of the load, current of the load, rated voltage of the load, speed of the vehicle, acceleration of the vehicle, deceleration of the vehicle, a degree of depression of an accelerator pedal, a degree of depression of a brake pedal, fluctuation of a ripple current of the battery, outside temperature, a difference between battery temperature and an outside temperature, a regenerative braking amount, or a performance limit point of the battery.

9. The battery protection method of claim 8, wherein determining whether the regenerative braking amount needs to be controlled comprises:
determining that the regenerative braking amount needs to be controlled in response to a determination that the battery needs to be protected.

10. The battery protection method of claim 9, wherein determining whether the regenerative braking amount needs to be controlled comprises:
determining that the battery needs to be protected in response to a determination that a decrease in the SoC of the battery needs to be delayed.

11. The battery protection method of claim 9, wherein determining whether the regenerative braking amount needs to be controlled comprises:
determining that the battery needs to be protected in response to a determination that the SoH of the battery needs to be improved.

12. The battery protection method of claim 9, wherein determining whether the regenerative braking amount needs to be controlled comprises:
determining that the battery needs to be protected in response to the speed of the vehicle being maintained within a preset range for a preset time.

13. The battery protection method of claim 9, wherein determining whether the regenerative braking amount needs to be controlled comprises:
determining that the battery needs to be protected in a sudden braking section.

14. The battery protection method of claim 9, wherein determining whether the regenerative braking amount needs to be controlled comprises:
determining that the battery needs to be protected in response to the outside temperature being equal to or higher than the battery temperature by an amount equal to or greater than a preset value.

15. The battery protection method of claim 9, wherein controlling the regenerative braking amount to increase comprises:
increasing regenerative braking force.

16. An apparatus comprising:
at least one memory storing instructions; and
at least one processor,
wherein the at least one processor, by executing the instructions, is configured to:
monitor a state of a vehicle,
determine, using a result of monitoring the state of the vehicle, that a high power peak has occurred when power of a battery is equal to or greater than a first threshold value,
control power consumption of a load so that the high power peak is distributed, and
compensate for power consumption of the load,
wherein the state of the vehicle includes at least one of power of the battery, voltage of the battery, current of the battery, rated voltage of the battery, state of charge (SoC) of the battery, state of health (SoH) of the battery, power consumption of the load, output of the load, voltage of the load, current of the load, rated voltage of the load, speed of the vehicle, acceleration of the vehicle, deceleration of the vehicle, a degree of depression of an accelerator pedal, a degree of depression of a brake pedal, fluctuation of a ripple current of the battery, outside temperature, a difference between battery temperature and an outside temperature, a regenerative braking amount, or a performance limit point of the battery.

17. The apparatus of claim 16, wherein
the at least one processor is further configured to:
control the power consumption of the load to decrease so that the high power peak is distributed, and
control the power consumption of the load to increase by an amount of the power consumption of the load controlled to decrease to compensate for the power consumption of the load.

18. An apparatus comprising:
at least one memory storing instructions; and
at least one processor,
wherein the at least one processor, by executing the instructions, is configured to:
monitor a state of a vehicle,
determine, using a result of monitoring the state of the vehicle, whether to control a regenerative braking amount, and
control the regenerative braking amount to increase,
wherein the state of the vehicle includes at least one of power of a battery, voltage of the battery, current of the battery, rated voltage of the battery, state of charge (SoC) of the battery, state of health (SoH) of the battery, power consumption of a load, output of the load, voltage of the load, current of the load, rated voltage of the load, speed of the vehicle, acceleration of the vehicle, deceleration of the vehicle, a degree of depression of an accelerator pedal, a degree of depression of a brake pedal, fluctuation of a ripple current of the battery, outside temperature, a difference between battery temperature and an outside temperature, a regenerative braking amount, or a performance limit point of the battery.

19. The apparatus of claim 18, wherein the at least one processor is further configured to determine that the regenerative braking amount needs to be controlled when it is determined that the battery needs to be protected.

20. The apparatus of claim 19, wherein the at least one processor is further configured to determine that the battery needs to be protected when it is determined that a reduction of the SoC of the battery needs to be delayed or the SoH of the battery needs to be improved.
